(19) United States
(12) Patent Application Publication
(10) Pub. No.: US 2021/0146594 A1
(43) Pub. Date: May 20, 2021

(54) METHOD AND DEVICE FOR PRODUCING CONTAINERS FROM PREFORMS

(71) Applicant: KHS Corpoplast GmbH, Hamburg (DE)

(72) Inventor: Marcus Wenig, Reinfeld (DE)

(73) Assignee: KHS Corpoplast GmbH, Hamburg (DE)

(21) Appl. No.: 16/950,069

(22) Filed: Nov. 17, 2020

(30) Foreign Application Priority Data
Nov. 19, 2019 (DE) 10 2019 131 242.6

(51) Int. Cl. B29C 49/12; B29C 49/64; B29C 49/48

(52) U.S. Cl. CPC B29C 49/12; B29L 2031/712; B29C 49/48; B29C 49/64

(57) ABSTRACT

A method and a device for producing containers formed by pneumatic or hydraulic pressure (i.e. blowing pressure or the pressure of a fluid to be filled) from preforms with a blow mold are provided. The blow mold has a bottom mold with an axially displaceable bottom die, wherein for exerting a counterforce on the bottom die is configured to bias the bottom die into an extended position being arranged in the interior of the blow mold and being extended from the bottom mold, wherein the stretching rod is configured to displace the bottom die against the counterforce into a retracted position substantially being arranged in the bottom mold. The counterforce clamps the preform stretched by the stretching rod between the tip of the stretching rod and the bottom die so that the container being formed is always kept centered.

### TECHNICAL FIELD

The disclosure relates to a method and a device for producing containers formed from preforms by pneumatic or hydraulic pressure (i.e. blowing pressure or the pressure of a fluid to be filled).

### BACKGROUND

Blow-molded containers are usually produced by expanding a preform made of a thermoplastic material such as PET into a blow mold by applying blow pressure and then filling it with a product (especially a fluid) in a subsequent filling station. It is also known that a preform is expanded into a blow mold by the pressure of a fluid to be filled, so that forming and filling represent a common method (also called “formfill”). Methods and devices of this kind are known from WO 2011/076167 A1 and WO 2012/130374 A1.

From WO 2012/130374 A1, it is also known that guide and forming elements, which act on a preform from outside for controlled radial and axial stretching, are heated by means of electrical resistance heating to further improve the forming method.

According to WO 2005/023517 A1, however, a hollow stretching rod used to stretch a preform is used to direct a pressurized gas into the forming container, especially towards the bottom of the container, in order to cool it down more quickly. The processing time required for the forming and cooling of the container may be reduced by suitable timing of the supply of a pressurized gas through an annular gap surrounding the stretching rod as well as a suitable dimensioning of the two gas pressures.

From U.S. Pat. No. 9,688,013 B2, a method and a device for blow molding of containers by a blow mold is known, which has a bottom that can be moved in axial direction of the blow mold. Furthermore, a stretching rod is provided which is axially movable relative to the blow mold and within the preform. During the blowing process, the free end of the stretching rod is first advanced to the bottom of the blow mold and presses the bottom of the preform against the upper side of the bottom of the blow mold, which is profiled in a certain way. In order to ensure that the container blown out of the preform is in complete contact with the inner wall of blow mold and with the top face of the bottom, the bottom of the blow mold is raised while maintaining high blowing pressure. Synchronously with lifting the bottom, the stretching rod is either actively or passively retracted, so that on the one hand the container is kept centered, but on the other hand the stretching rod no longer exerts any significant pressure on the container bottom to prevent damaging the container bottom.

However, the disadvantage of this method is that the blowing pressure, the lifting of the bottom and the retraction of the stretching bar must be coordinated very precisely in terms of time and quantity in order to ensure the centering of the container and to achieve the desired bottom shape on the one hand, but on the other hand to avoid damaging the container bottom in particular.

### SUMMARY

One of the objects underlying the invention is to create a method and a device for producing containers formed from preforms by pneumatic or hydraulic pressure, with which a reliable centering of the containers without the risk of damaging the container bottoms can be achieved in a relatively simple and cost-effective manner. This object is solved with a method and a device as described herein.

An advantage of these solutions is that the preform is clamped with its tip between the tip of the stretching rod and the bottom die, thus always keeping centered the container formed by stretching and forming. The force exerted on the bottom die for this purpose (“counterforce”) counteracts the force exerted on the bottom die by the stretching rod and is dimensioned in such a way that on the one hand a reliable centering of the preform or the container being formed is ensured and on the other hand damage to the container is avoided.

The counterforce can be generated or exerted mechanically by a spring, pneumatically or hydraulically by a pressurized fluid (gas or liquid) and/or magnetically by a permanent magnet or electromagnet.

Furthermore, the bottom die is preferably cooled during stretching, so that the areas of the preform, in particular its top, which are pressed against the bottom die by the stretching rod, are also cooled.

An advantage of this solution is that the cooling of the top of the preform, in particular of the area of the top of the preform, which occurs simultaneously with or shortly after the start of stretching and forming, shortens the time required for blow molding a container compared to the known methods described above, thus increasing the number of containers that can be produced per unit of time without impairing their quality.

EP 2 338 830 refers to a “Cooling device for stabilizing a container structure”, in which the bottom areas of the containers are cooled during and/or after filling with a heated fluid (“hotfill”) by a cooling device in order to prevent the bottom area and in particular the base of the container from being deformed unintentionally due to the high thermal and pressure load caused by the fluid. However, this state of the art only concerns problems in connection with the filling of containers already manufactured in advance and is therefore not considered relevant.

The cooling of the bottom die is preferably done by a coolant such as water, which is fed through channels in the bottom die.

Preferably, the distance between the extended position and the retracted position of the bottom die is adjustable by an adjustable stop.

By selecting this distance appropriately, the timing between stretching or forming and the simultaneous or delayed cooling of the preform can be optimized in order to achieve a desired degree of cooling of the preform during forming, especially in connection with the temperature of the coolant. The resulting longer cooling of the tops of the preform allows higher machine outputs (station output per hour) to be achieved.

The bottom die preferably engages in the retracted position. After the formed container has been removed from the blow mold, the engagement releases preferably automatically so that the counterforce pushes back the bottom die into the extended position.

The following detailed description is merely exemplary in nature and is not intended to limit the invention or the application and uses of the invention. Furthermore, there is no intention to be bound by any theory presented in the preceding background or the following detailed description.

### BRIEF DESCRIPTION OF THE DRAWINGS

FIG. 1 shows a first phase (initial state) of a blow molding method;

FIG. 2 shows a second phase (initial state) of blow molding;

FIG. 3 shows a third phase (clamping and cooling) of blow molding;

FIG. 4 shows a fourth phase (stretching) of blow molding;

FIG. 5 shows a fifth phase (springing back) of blow molding;

FIG. 6 shows a sixth phase (initial state) of blow molding; and

FIG. 7 shows an alternative exemplary embodiment of the disclosure.

### DETAILED DESCRIPTION

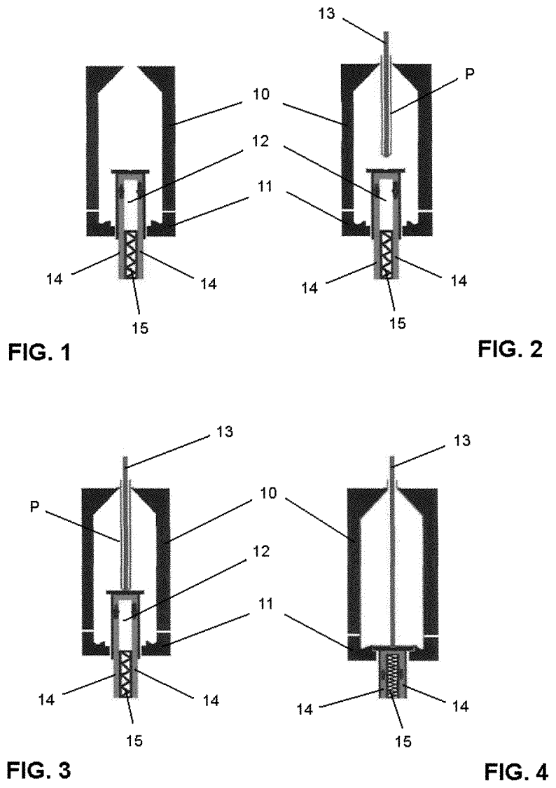

FIGS. 1 to 6 show a preferred first exemplary embodiment. Those figures show a blow mold 10 with a bottom mold 11. A bottom die 12 is integrated into the bottom mold 11, which is movably guided in the axial direction of the blow mold 10. The blow mold 10 further comprises a stretching rod 13, which is also movably guided in the axial direction of the blow mold 10. Preferably, the bottom die 12 and stretching rod 13 are centered in the blow mold 10.

The stretching rod 13 is moved axially into and out of the blow mold 10 in the known manner by a drive (not shown).

Furthermore, a pusher 15 is provided which serves to exert a counterforce on the bottom die 12 and prestresses it axially in the direction of the interior of the blow mold 10, i.e. into an extended position being inside the blow mold 10 and extended from the bottom mold 11 of the blow mold 10. The pusher is realized in the form of a spring 15 according to FIGS. 1 to 7. As already mentioned, the counterforce can also be generated pneumatically or hydraulically by a pressurized fluid (gas or liquid) and/or magnetically by a permanent magnet or electromagnet.

The extended position of the bottom die 12 is preferably a stop position at which the axial movement towards the inside of the blow mold 10 ends by a mechanical stop acting on the bottom die 12. Such a mechanical stop is usually provided, for example, as part of an axial guide for the bottom die 12 and therefore does not need to be explained further.

This stop can preferably be adjusted in such a way that the distance between the extended position in the base mold 11 and a retracted position of the bottom die 12 essentially is adjustable.

The bottom die 12 has one or more channels 14 inside, through which a coolant (for example water) can be passed to cool the bottom die 12. Inlets and outlets for the coolant as well as corresponding pumping devices are realized in the usual manner and are therefore not shown.

FIGS. 1 to 6 show successive phases during a method for producing containers formed from preforms by pneumatic or hydraulic pressure (i.e. blowing pressure or the pressure of a fluid to be filled).

FIG. 1 shows a first phase in which the blow mold 10 is in an initial state. During this phase, the spring 15 presses the bottom die 12 into the extended position, i.e. an upper stop position (initial position) in which the bottom die 12 projects into the blow mold 10. The stretching rod 13 (not shown) is in an upper position outside the blow mold 10.

FIG. 2 shows a second phase (stretching) in which a preform P is placed in the (locked) blow mold 10 and is stretched by the stretching rod 13 guided in this mold. For this purpose, the stretching rod 13 is moved into the blow mold 10 in the known manner. In the state shown in FIG. 2, the distance between the top of the preform P and the opposite face of the bottom die 12 is still about 10 mm.

In the third phase shown in FIG. 3, the stretching rod 13 and thus also the top of the preform P has reached the bottom die 12 and is thus clamped between the tip of the stretching rod 13 and the opposite face of the bottom die 12 according to the counterforce exerted by the spring 15. At the same time, the coolant is passed through the channels 14 of the bottom die 12 so that the preform P and in particular its tip touching the bottom die 12 (or its end face) is cooled.

After the preform P has been stretched by the stretching rod 13 and has been expanded against the inner wall of the blow mold 10 by the medium introduced under pressure into the preform P, the fourth phase shown in FIG. 4 is reached, in which the stretching rod 13 presses the bottom die 12 against the counterforce exerted by the spring 15 into its retracted position, essentially in the bottom mold 11, in which the bottom die 12 engages with a releasable lock. The preform P is now pressure-molded into a container.

By appropriately selecting the distance between the bottom die 12 in its extended position and the retracted position (i.e. by adjusting the stop as explained above), the duration for cooling the preform P or the container formed from the preform by the bottom die 12 can be determined.

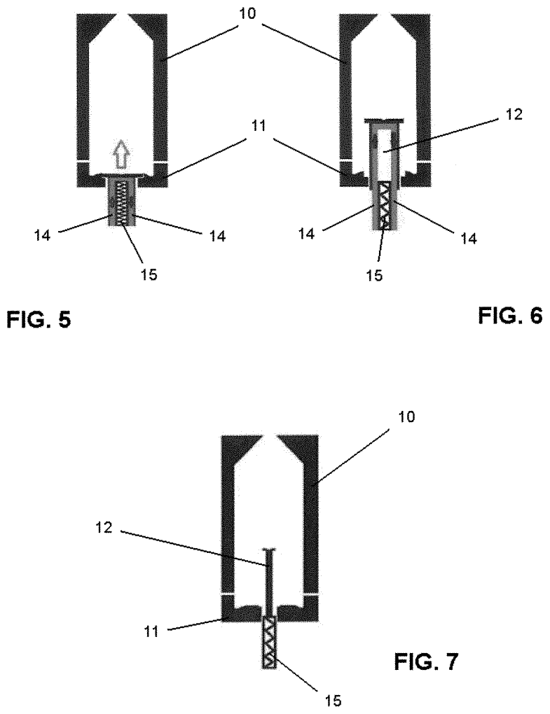

After reaching the fourth phase according to FIG. 4, the stretching rod 13 may be retracted, the blow mold 10 may be opened, the container may be removed from the blow mold 10 and the blow mold 10 may be closed again. Preferably, when the container is removed or the blow mold 10 is closed, the locking mechanism of the bottom die 12 is also released so that the bottom die 12 is then pushed back into its extended position (upper stop position) by the counterforce of the spring 15 according to the fifth phase shown in FIG. 5 and, according to FIG. 6, the blow mold 10 is returned to its initial state shown in FIG. 1. The sequence can then be repeated with the next preform P fed in.

FIG. 7 shows a simplified embodiment of the invention. This embodiment differs from the preferred embodiment shown in FIGS. 1 to 6 in that the bottom die 12 has no channels 14 and is therefore not cooled. However, the sequences described above for forming and stretching the preform P remain unchanged, so that also in this embodiment, the preform P is clamped with its tip between the tip of the stretching rod 13 and the bottom die 12 (or its end face) in accordance with the counterforce of the spring 15 and the container being formed is always kept centered.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

What is claimed is:

1. A method for producing a container formed by pneumatic or hydraulic pressure, comprising:
providing a preform;
arranging the preform in a blow mold;
stretching the preform towards an axially displaceable bottom die with a stretching rod;
biasing, by a counterforce, the bottom die into an extended position in an interior of the blow mold extended from a bottom mold of the blow mold; and
displacing, during stretching with the stretching rod, the bottom die against the counterforce into a retracted position substantially being arranged in the bottom mold.

2. The method according to claim 1, wherein the counterforce is generated by one or more of a spring, a pressurized fluid, a permanent magnet, and an electromagnet.

3. The method according to claim 1, further comprising cooling an area of the preform adjacent to the bottom die during stretching by cooling the bottom die.

4. The method according to claim 1,
wherein the bottom die releasably engages in the retracted position when the latter is reached,
wherein the engagement is released by removing a formed container from the blow mold or by closing the blow mold,
wherein after releasing the engagement the counterforce pushes the bottom die into the extended position.

5. A device for producing containers formed by pneumatic or hydraulic pressure from preforms, comprising:
a blow mold; and
a stretching rod for stretching the preforms,
wherein the blow mold comprises
a bottom mold with an axially displaceable bottom die, and
a pusher for exerting a counterforce on the bottom die,
wherein the pusher is configured to bias the bottom die into an extended position being arranged in an interior of the blow mold and being extended from the bottom mold, and
wherein the stretching rod is configured to displace the bottom die against the counterforce into a retracted position substantially being arranged in the bottom mold.

6. The device according to claim 5, wherein the pusher for exerting the counterforce comprises a spring, a pressurized fluid, a permanent magnet, or an electromagnet.

7. The device according to claim 5, wherein the bottom die comprises a plurality of coolant channels.

8. The device according to claim 5, wherein an adjustable stop is configured to adjust a distance between the extended position and the retracted position of the bottom die.

9. The device according to claim 5, wherein the bottom die releasably engages in the retracted position.

10. The device according to claim 9,
wherein the engagement is released after removing a molded container or after closing the blow mold, and
wherein the pusher is configured to push the bottom die to the extended position.
